(19) United States
(12) Patent Application Publication
(10) Pub. No.: US 2025/0267551 A1
(43) Pub. Date: Aug. 21, 2025

(54) COORDINATE SIGNALING FOR A RESTRICTED GEOGRAPHIC AREA

(71) Applicant: QUALCOMM Incorporated, San Diego, CA (US)

(72) Inventors: Umesh PHUYAL, San Diego, CA (US); Stefano FACCIN, San Ysidro, CA (US); Sitaramanjaneyulu KANAMARLAPUDI, San Diego, CA (US); Le LIU, San Jose, CA (US); Chiranjib SAHA, Lakeside, CA (US); Alberto RICO ALVARINO, San Diego, CA (US)

(21) Appl. No.: 19/052,073

(22) Filed: Feb. 12, 2025

Related U.S. Application Data
(60) Provisional application No. 63/554,116, filed on Feb. 15, 2024.

(51) Int. Cl. H04W 48/04; G08G 5/59; H04W 4/021; H04W 72/0453

(52) U.S. Cl. CPC H04W 48/04; G08G 5/59; H04W 4/022; H04W 72/0453

(57) ABSTRACT

Methods, systems, and devices for wireless communications are described. The described techniques include coordinating signaling for a restricted geographic area or zone. A user equipment (UE) (e.g., aerial UE) receives one or more messages indicating geographic coordinates of a restricted geographic area, the geographic coordinates corresponding to boundaries of a polygon that defines an area or a volume of the restricted geographic area. The one or more messages further indicate a transmission restriction policy associated with the restricted geographic area. The UE performs a procedure that complies with the transmission restriction policy based on a current geolocation of the UE relative to the geographic coordinates corresponding to the boundaries of the polygon associated with the restricted geographic area.

### CROSS REFERENCE

The present Application for Patent claims benefit of U.S. Provisional Patent Application No. 63/554,116 by PHUYAL et al., entitled “COORDINATE SIGNALING FOR A RESTRICTED GEOGRAPHIC AREA,” filed Feb. 15, 2024, which is assigned to the assignee hereof, and which is expressly incorporated by reference in its entirety herein.

### FIELD OF TECHNOLOGY

The following relates to wireless communications, including coordinate signaling for a restricted geographic area.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support coordinate signaling for a restricted geographic area. For example, the described techniques provide for an aerial user equipment (UE) to enter and operate in a geographical area with transmission restrictions. In some examples, the described techniques provide for a UE, such as an aerial UE, to receive signaling that indicates geographic coordinates forming boundaries of a polygon (e.g., to form a two-dimension (2D) or three-dimension (3D) polygon area) of a restricted area and a type of the restricted area (e.g., no-transmit zone, no-fly zone, or no-departure zone). The signaling may further indicate a transmission restriction policy associated with the restricted area (e.g., indicating permission to transmit over a frequency band while indicating prohibition to transmit over a different frequency band, as well as time periods during which the UE may transmit). The UE may receive signaling based on a release version associated with the UE (e.g., an early release version aerial UE receives signaling indicating a bar from transmitting in the restricted area while a newer version aerial UE receives signaling indicating permission and policy to transmit in the restricted area for the restricted area type).

A method for wireless communications by a UE is described. The method may include receiving one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area and performing a procedure that complies with the transmission restriction policy based on a current geolocation of the UE relative to the geographic coordinates corresponding to the one or more boundaries of the polygon associated with the restricted geographic area.

A UE for wireless communications is described. The UE may include one or more memories storing processor executable code, and one or more processors coupled with the one or more memories. The one or more processors may individually or collectively be operable to execute the code to cause the UE to receive one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area and perform a procedure that complies with the transmission restriction policy based on a current geolocation of the UE relative to the geographic coordinates corresponding to the one or more boundaries of the polygon associated with the restricted geographic area.

Another UE for wireless communications is described. The UE may include means for receiving one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area and means for performing a procedure that complies with the transmission restriction policy based on a current geolocation of the UE relative to the geographic coordinates corresponding to the one or more boundaries of the polygon associated with the restricted geographic area.

A non-transitory computer-readable medium storing code for wireless communications is described. The code may include instructions executable by one or more processors to receive one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area and perform a procedure that complies with the transmission restriction policy based on a current geolocation of the UE relative to the geographic coordinates corresponding to the one or more boundaries of the polygon associated with the restricted geographic area.

Some examples of the method, UEs, and non-transitory computer-readable medium described herein may further include operations, features, means, or instructions for receiving one or more messages indicating an area type indicator for the restricted geographic area, the area type indicator indicating that the restricted geographic area may be a no fly zone, a no uplink transmission zone, or a no departure zone.

Some examples of the method, UEs, and non-transitory computer-readable medium described herein may further include operations, features, means, or instructions for receiving the one or more messages indicating the geographic coordinates may be based on a capability of the UE.

In some examples of the method, UEs, and non-transitory computer-readable medium described herein, the one or more messages indicates: the geographic coordinates of the restricted geographic area and at least one frequency band associated with the restricted geographic area; or the geographic coordinates of the restricted geographic area, the at least one frequency band associated with the restricted geographic area and a time period during which the transmission restriction policy applies.

Some examples of the method, UEs, and non-transitory computer-readable medium described herein may further include operations, features, means, or instructions for receiving a control message that enables or disables the transmission restriction policy for the restricted geographic area.

In some examples of the method, UEs, and non-transitory computer-readable medium described herein, the transmission restriction policy indicates a restriction prohibiting transmission using at least a first frequency band within the restricted geographic area, permits transmission using a second frequency band within the restricted geographic area, or both.

In some examples of the method, UEs, and non-transitory computer-readable medium described herein, performing the procedure may include operations, features, means, or instructions for transmitting a first message in accordance with the transmission power limit.

In some examples of the method, UEs, and non-transitory computer-readable medium described herein, receiving the one or more messages may include operations, features, means, or instructions for receiving a radio resource control message (RRC), a system information block (SIB), a downlink control information (DCI) message, or a medium access control element (MAC-CE) message, based on the UE being disposed inside of a coverage area associated with a network entity.

In some examples of the method, UEs, and non-transitory computer-readable medium described herein, receiving the one or more messages may include operations, features, means, or instructions for receiving one or more application layer messages or one or more sidelink messages based on the UE being disposed outside of a coverage area associated with a network entity.

In some examples of the method, UEs, and non-transitory computer-readable medium described herein, receiving the one or more messages may include operations, features, means, or instructions for receiving a bit field including a barring bit indicating whether establishing connectivity with a cell within the restricted geographic area may be barred.

In some examples of the method, UEs, and non-transitory computer-readable medium described herein, receiving the one or more messages may include operations, features, means, or instructions for receiving a network signaling field including a value indicating that establishing connectivity with a cell may be permitted when the UE may be located outside of the restricted geographic area and that establishing connectivity with the cell may be not permitted when the UE may be located within the restricted geographic area.

In some examples of the method, UEs, and non-transitory computer-readable medium described herein, the network signaling field includes a first network signaling value indicating an area type, a second network signaling value indicating the geographic coordinates, or both, or the geographic coordinates are associated with an altitude for the restricted geographic area.

In some examples of the method, UEs, and non-transitory computer-readable medium described herein, receiving the one or more messages may include operations, features, means, or instructions for receiving signaling indicating that transmission may be barred in the restricted geographic area or indicating permission to transmit in accordance with the transmission restriction policy in the restricted geographic area.

A method for wireless communications by a network entity is described. The method may include generating one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area and outputting the one or more messages to a UE.

A network entity for wireless communications is described. The network entity may include one or more memories storing processor executable code, and one or more processors coupled with the one or more memories. The one or more processors may individually or collectively be operable to execute the code to cause the network entity to generate one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area and output the one or more messages to a UE.

Another network entity for wireless communications is described. The network entity may include means for generating one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area and means for outputting the one or more messages to a UE.

A non-transitory computer-readable medium storing code for wireless communications is described. The code may include instructions executable by one or more processors to generate one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area and output the one or more messages to a UE.

Some examples of the method, network entities, and non-transitory computer-readable medium described herein may further include operations, features, means, or instructions for outputting, during a handover procedure, an indication of the area type indicator and the transmission restriction policy associated with the restricted geographic area, to a handover candidate network entity.

Some examples of the method, network entities, and non-transitory computer-readable medium described herein may further include operations, features, means, or instructions for obtaining an indication an area type capability associated with the handover candidate network entity, where transmitting the indication of the area type indicator and the transmission restriction policy may be based on the area type capability associated with the handover candidate network entity.

Some examples of the method, network entities, and non-transitory computer-readable medium described herein may further include operations, features, means, or instructions for obtaining, during the handover procedure, an indication of handover failure based on the area type capability being incompatible with the transmission restriction policy associated with the area type.

Some examples of the method, network entities, and non-transitory computer-readable medium described herein may further include operations, features, means, or instructions for outputting the one or more messages indicating the geographic coordinates may be based on a capability of the UE.

In some examples of the method, network entities, and non-transitory computer-readable medium described herein, the one or more messages indicates: the geographic coordinates of the restricted geographic area and at least one frequency band associated with the restricted geographic area; or the geographic coordinates of the restricted geographic area, the at least one frequency band associated with the restricted geographic area and a time period during which the transmission restriction policy applies.

Some examples of the method, network entities, and non-transitory computer-readable medium described herein may further include operations, features, means, or instructions for outputting a control message that enables or disables the transmission restriction policy for the restricted geographic area.

In some examples of the method, network entities, and non-transitory computer-readable medium described herein, the transmission restriction policy indicates a restriction prohibiting transmission using at least a first frequency band within the restricted geographic area, permits transmission using a second frequency band within the restricted geographic area, or both.

In some examples of the method, network entities, and non-transitory computer-readable medium described herein, the transmission restriction policy indicates a transmission power limit for transmissions within the restricted geographic area.

In some examples of the method, network entities, and non-transitory computer-readable medium described herein, outputting the one or more messages may include operations, features, means, or instructions for outputting a RRC message, a SIB, a DCI message, or a MAC-CE message, based on the UE being disposed inside of a coverage area associated with a network entity.

In some examples of the method, network entities, and non-transitory computer-readable medium described herein, outputting the one or more messages may include operations, features, means, or instructions for outputting one or more application layer messages or one or more sidelink messages based on the UE being disposed outside of a coverage area associated with a network entity.

In some examples of the method, network entities, and non-transitory computer-readable medium described herein, outputting the one or more messages may include operations, features, means, or instructions for outputting a bit field including a barring bit indicating whether establishing connectivity with a cell within the restricted geographic area may be barred.

In some examples of the method, network entities, and non-transitory computer-readable medium described herein, outputting the one or more messages may include operations, features, means, or instructions for outputting a network signaling field including a value indicating that establishing connectivity with a cell may be permitted when the UE may be located outside of the restricted geographic area and that establishing connectivity with the cell may be not permitted when the UE may be located within the restricted geographic area.

In some examples of the method, network entities, and non-transitory computer-readable medium described herein, the network signaling field includes a first network signaling value indicating an area type or a second network signaling value indicating the geographic coordinates or the geographic coordinates are associated with an altitude for the restricted geographic area.

Some examples of the method, network entities, and non-transitory computer-readable medium described herein may further include operations, features, means, or instructions for outputting one or more messages indicating an area type indicator for the restricted geographic area, the area type indicator indicating that the restricted geographic area may be a no fly zone, a no uplink transmission zone, or a no departure zone.

Some examples of the method, network entities, and non-transitory computer-readable medium described herein may further include operations, features, means, or instructions for outputting signaling indicating that transmission may be barred in the restricted geographic area or indicating permission to transmit in accordance with the transmission restriction policy in the restricted geographic area.

### BRIEF DESCRIPTION OF THE DRAWINGS

FIG. 1 shows an example of a wireless communications system that supports coordinate signaling for a restricted geographic area in accordance with one or more aspects of the present disclosure.

FIG. 2 shows an example of a wireless communications system that supports coordinate signaling for a restricted geographic area in accordance with one or more aspects of the present disclosure.

FIG. 3 shows an example of a process flow that supports coordinate signaling for a restricted geographic area in accordance with one or more aspects of the present disclosure.

FIGS. 4 and 5 show block diagrams of devices that support coordinate signaling for a restricted geographic area in accordance with one or more aspects of the present disclosure.

FIG. 6 shows a block diagram of a communications manager that supports coordinate signaling for a restricted geographic area in accordance with one or more aspects of the present disclosure.

FIG. 7 shows a diagram of a system including a device that supports coordinate signaling for a restricted geographic area in accordance with one or more aspects of the present disclosure.

FIGS. 8 and 9 show block diagrams of devices that support coordinate signaling for a restricted geographic area in accordance with one or more aspects of the present disclosure.

FIG. 10 shows a block diagram of a communications manager that supports coordinate signaling for a restricted geographic area in accordance with one or more aspects of the present disclosure.

FIG. 11 shows a diagram of a system including a device that supports coordinate signaling for a restricted geographic area in accordance with one or more aspects of the present disclosure.

FIGS. 12 through 15 show flowcharts illustrating methods that support coordinate signaling for a restricted geographic area in accordance with one or more aspects of the present disclosure.

### DETAILED DESCRIPTION

Some geographical areas may be deemed as “no-transmit zones,” where aerial user equipment (UE) are not allowed to operate in a certain frequency band. For example, an area with a highly sensitive radiotelescope which scans using radio waves may be deemed a no-transmit zone for aerial UEs, as transmissions from the aerial UEs may cause interference to the radiotelescope. In some examples, restrictions for no-transmit zones for aerial UEs may be extensive, such as not allowing any transmission in specific radio frequency spectrum bands while an aerial UE is in a no-transmit zone. However, in some examples, some of the UEs in the no-transmit zones may otherwise be permitted to transmit within certain coordinates, or within certain transmission power limit, based on one or more conditions (e.g., during a time period), or based on belonging to a certain release version. Current techniques do not support signaling to facilitate such transmission restriction exceptions.

The UE may receive signaling that indicates geographic coordinates forming boundaries of a polygon (e.g., to form a two-dimension (2D) or three-dimension (3D) polygon area) of a restricted area and a type of the restricted area (e.g., no-transmit zone, no-fly zone, or no-departure zone). The signaling may further indicate a transmission restriction policy associated with the restricted area (e.g., indicating permission to transmit over a frequency band while indicating prohibition to transmit over a different frequency band, as well as time periods during which the UE may transmit). The UE may receive signaling based on a release version associated with the UE (e.g., an early release version aerial UE receives signaling indicating a bar from transmitting in the restricted area while a newer version aerial UE receives signaling indicating permission and policy to transmit in the restricted area for the restricted area type).

Although the techniques described herein are discussed with respect to an aerial environment with an aerial UE, the techniques described herein may additionally or alternatively apply to non-aerial UEs positioned relative to or within a restricted geographic area. For example, the non-aerial UEs may be positioned relative to or within a ground level area (e.g., not in the air). In some cases, the zone may include a portion that is partially in air and a portion on the ground, such that the UE may be aerial or non-aerial. Aspects of the disclosure are initially described in the context of wireless communications systems. Aspects of the disclosure are further illustrated by and described with reference to apparatus diagrams, system diagrams, and flowcharts that relate to coordinate signaling for a restricted geographic area.

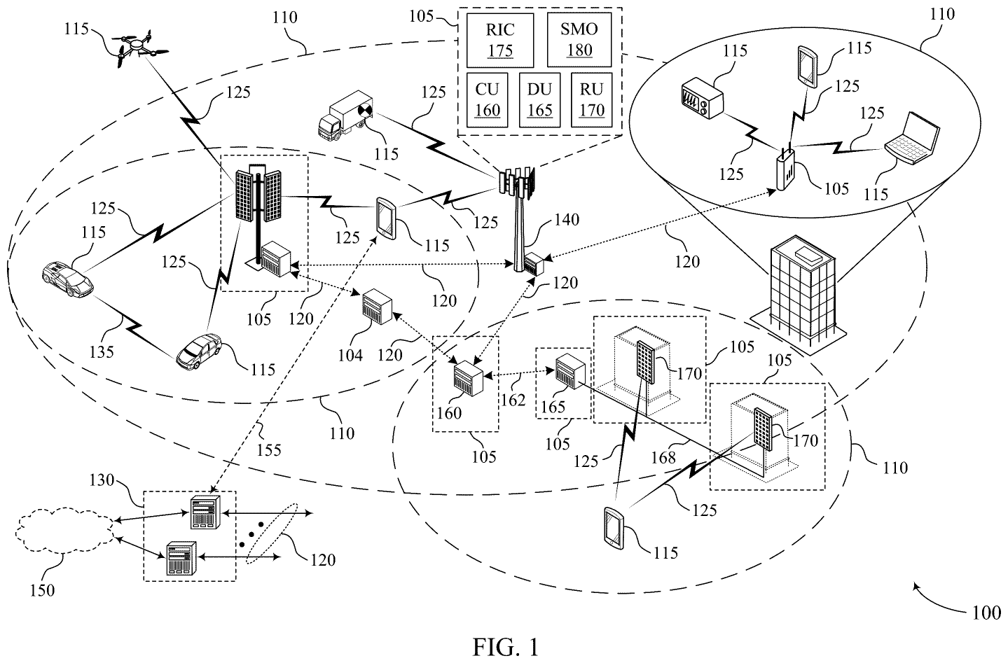

FIG. 1 shows an example of a wireless communications system 100 that supports coordinate signaling for a restricted geographic area in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, some geographical areas may be deemed as “no-transmit zones,” where a UE 115 (e.g., an aerial UE) are not allowed to operate in a certain frequency band. For example, an area with a highly sensitive radiotelescope which scans using radio waves may be deemed a no-transmit zone for UEs 115, as transmissions from the UEs 115 may cause interference to the radiotelescope. In some examples, restrictions for no-transmit zones for UEs 115 may be extensive, such as not allowing any transmission in specific radio frequency spectrum bands while a UE 115 is in a no-transmit zone. However, in some examples, some of the UEs 115 in the no-transmit zones may otherwise be permitted to transmit within certain coordinates, based on one or more conditions (e.g., during a time period), or based on belonging to a certain release version. Current techniques do not support signaling to facilitate such transmission restriction exceptions for a UE 115.

The UE 115 may receive signaling that indicates geographic coordinates forming boundaries of a polygon (e.g., to form a two-dimension (2D) or three-dimension (3D) polygon area) of a restricted area and a type of the restricted area (e.g., no-transmit zone, no-fly zone, or no-departure zone). The signaling may further indicate a transmission restriction policy associated with the restricted area (e.g., indicating permission to transmit over a frequency band while indicating prohibition to transmit over a different frequency band, as well as time periods during which the UE 115 may transmit). The UE 115 may receive signaling based on a release version associated with the UE 115 (e.g., an early release version UE 115 receives signaling indicating a bar from transmitting in the restricted area while a newer version UE 115 receives signaling indicating permission and policy to transmit in the restricted area for the restricted area type).

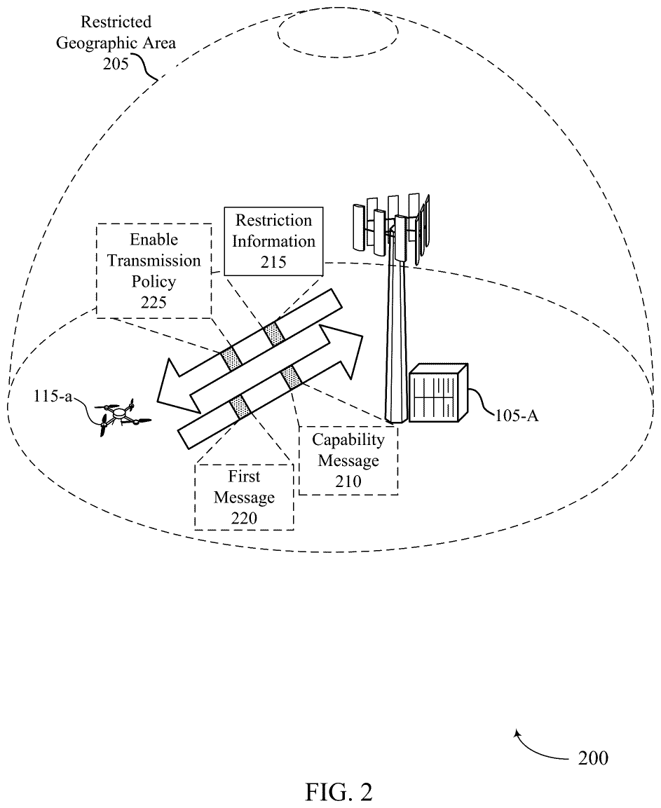

FIG. 2 shows an example of a wireless communications system 200 that supports coordinate signaling for a restricted geographic area in accordance with one or more aspects of the present disclosure. The wireless communications system 200 may include a UE 115-a and a network entity 105-a. The UE 115 a may be an example of a UE 115 described herein, such as an aerial UE 115. The network entity 105-a may be an example of a network node or a network entity 105 described herein.

In some examples, the UE 115-a (e.g., an aerial UE or a drone) may be a no-transmit zone (NTZ) or no-fly zones (NFZ) that limit the transmissions from drones, for example, in order not to cause too much interference at a nearby base station. In such zones, a mechanism, such as the techniques discussed herein, may be used to ensure that the UE 115-a complies with the no-transmit zones. For example, the techniques discussed herein may including, for NTZ, defining transmission policies according to regional or national protocols, mapping to one or more cells, a fraction of a cell, overlapping different cells in a mobile operator network, and/or coordinating mapping of the cells with RAN working groups (WGs). The techniques discussed herein may facilitate in ensuring that a UE 115-a complies with no-transmit zones. For example, compliance may include determining whether a mobile network cell overlaps completely or partially with the NTZ and uses the restricted frequency bands of the NTZ, whether policies may be used to differentiate UEs 115 that support functions defined for NTZs (e.g., latest version of UEs 115) and aerial UEs that do not support functions defined for NTZs (e.g., older versions of UEs 115), or whether certain UE 115 behavior occurs when the UE 115-a approaches, enters, or exits the NTZ. Determining compliance may further include determining whether and how to enable configuration of NTZ information in the UE 115-a, whether to allow the enforcement of no-transmit zones for both UEs 115 in connected mode and UEs 115 in idle mode and/or how to allow enforcement, and how the UE 115 may interact with other regulatory services.

In some examples, the techniques discussed herein may include defining signaling for zones, coexistence between current and previous versions of UEs 115 (e.g., previous UE 115 versions may not support the NTZ signaling), and applying techniques to a “restricted geographic area” (e.g., a “special area”) instead of limiting to NTZ. The techniques applied for coexistence between current and previous versions of UEs 115 may facilitate compliance for backward compatibility, for example, for idle or connected modes or for handling special area information during a handover procedure.

The techniques discussed herein may apply to a “restricted geographic area.” The term “restricted geographic area” may refer to any area or space (e.g., two-dimension or three-dimension) associated with a communication restriction for the UE 115. That is, the restricted geographic area may not be limited to NTZ. Instead, the restricted geographic area may include the NTZ, as well as the NFZ, or other areas defined by geofencing. The restricted geographic area, such a geofenced area, may be designated based on one or more conditions, such as weather alerts associated with tornados, wild-fire zones, or other geofenced areas from which the UE 115-a may not depart. The restricted geographic area may include an NTZ, which may restrict radio frequency transmissions from the UE 115-a (e.g., drone, unmanned aerial vehicle (UAV), or aerial UE) in the zone. The NTZ may restrict transmissions but may not include a restriction on flying or receiving signals. The restricted geographic area may include an NFZ, which may restrict flying in the zone (e.g., cannot enter or fly, such that transmission and reception are implicitly restricted). The restricted geographic area may include a no-leaving zone (NLZ), which may restrict leaving the zone. In the NLZ, the UE 115-a may not leave the zone but transmissions and reception are permitted. The restriction may include a geofence so that the UE 115-a may not leave (e.g., pass the fence).

To illustrate, wireless communications system 200 may include a restricted geographic area 205. The restricted geographic area 205 may correspond to a geographical area where transmission from certain devices on certain radio frequency spectrum bands is restricted, as well as other conditions (e.g., for a time period). For example, the UE 115-a may be restricted from transmitting on a radio frequency spectrum band which the UE 115-a uses for communications (e.g., LTE or NR communications) while the UE 115-a is in the restricted geographic area 205 (e.g., where the special area is a NTZ). That is, one or more frequencies or frequency bands may be restricted from being used for transmissions within the restricted geographic area 205. The wireless communications system 200 may support techniques for the UE 115-a to identify the restricted geographic area 205 and operate in the restricted geographic area 205 according to transmission restrictions.

In some examples, the UE 115-a may transmit a capability message 210 indicating one or more capabilities of the UE 115-a. The capability message 210 may indicate that the UE 115-a supports restrictions or is able to support compliance with restrictions while operating in the restricted geographic area 205. In some examples, the capability message 210 may indicate a production or manufacturing version of the UE 115-a, such that the network entity 105-a may transmit a message indicating the transmission policy associated with the restricted geographic area 205 based on the version (e.g., different signaling based on version of the UE 115-a, such that different versions are associated with different capabilities with respect to compliance within the restricted geographic area 205).

In some examples, some operations or processes of the network may be based on radio capabilities of UE 115-a. The UE 115-a may report capability indicating whether the UE 115-a supports other frequency bands besides the frequency bands that are not allowed within the restricted geographic area 205. If the UE 115-a does not support other frequency bands, the network may consider the UE 115-a unreachable. If the UE 115-a does support other bands, the network may consider the UE 115-a reachable and available for at least downlink signaling. In some examples, the UE 115-a may receive paging signaling on the other bands which do not correspond to the restricted geographic area 205. After the UE 115-a enters the restricted geographic area 205, the UE 115-a may locally modify the radio capabilities of the UE 115-a and reselects to another band that does not correspond to the restricted geographic area 205. The UE 115-a may perform idle mode procedures for cell reselection after reselecting to a band that does not correspond to the restricted geographic area 205.

The UE 115-a may receive restriction information 215, which may indicate transmission restrictions for the restricted geographic area 205. In some examples, the restriction information 215 may identify one or more radio frequency bands where transmission by the UE 115-b is restricted or prohibited within the restricted geographic area 205. In some examples, the UE 115-a may transmit the capability message 210 to the network entity 105-a. In some examples, the network entity 105-a may transmit the restriction information 215 to the UE 115-a. In some other examples, separate devices, nodes, or entities may transmit and receive the capability message 210 or the restriction information 215. In some examples, the restriction information 215 may be referred to as the transmission restriction policy, indication of the area type (e.g., NFZ, NTZ, or NLZ), and the like.

In some examples, network entity 105-a may output a transmission policy enablement message 225 to the UE 115-a that enables a transmission policy. The transmission policy may correspond to the restricted geographic area 205, such that the network entity 105-a may enable the respective transmission policy while the UE 115-a is in the restricted geographic area 205 and disable it, for example, when the UE 115-a is no longer in the restricted geographic area 205, using the transmission policy enablement message 225.

In some examples, cells may correspond to the restricted geographic area 205. The wireless communication network may receive restriction information and map to a restricted geographic area. In some examples, the core network may receive an indication of the restricted geographic area 205 via an operations, administration, and management (OAM) entity from an external party (e.g., a government or entity enforcing the restricted geographic area 205). The core network may configure the UE 115-a with the restricted geographic area 205. For example, the network entity 105-a may transmit control signaling to configure the UE 115-a with the restricted geographic area via the restriction information 215.

For example, the restricted geographic area 205 may be implemented using NTZ, NFZ, geofencing, and the like. The network entity 105-a may output signaling indicating restriction information 215. The restriction information 215 may include geographic coordinates of the restricted geographic area 205 and an area type indicator for the restricted geographic area 205. The geographic coordinates may correspond to one or more boundaries of a polygon that defines an area or a volume of the restricted geographic area. The area type indicator may indicate that the restricted geographic area is an NFZ, a no uplink transmission zone (e.g., NTZ), a no departure zone (e.g., NLZ). The area type indicator may further indicate a transmission restriction policy associated with the restricted geographic area 205.

The geographic coordinates may correspond to or define a 2D boundary or a 3D boundary. For a 2D boundary, the restricted geographic area 205 may have, effectively, an infinite height. For a three-dimensional boundary, the restricted geographic area 205 may be a box, sphere, cylinder, ellipsoid, etc. In some examples, the restricted geographic area 205 may be limited in an altitude axis. For example, for a restricted geographic area 205 around an airport, the restricted geographic area 205 may extend to 500 meters in the air. Above 500 meters, there may not be a restricted geographic area 205 above the airport.

In some examples, the UE 115-a may transmit a first message 220 in accordance with a transmission power limit. That is, the UE 115-a may transmit a message based on the transmission policy for the restricted geographic area 205 after the transmission policy has been enabled for the UE 115-a (e.g., based on being in the restricted geographic area 205, capability of the UE 115-a, and the transmission policy for the area).

In some examples, the UE 115-a may receive coordinates to form the area or the volume identifying a “special area of interest,” which may be the restricted geographic area 205. The restricted geographic area 205 may include the NFZ, the NTZ, the NLZ, or the like, having boundaries corresponding to a 2D or a 3D polygon. As discussed herein, the restricted geographic area 205 may be further associated with a time period (e.g., time component), such that the transmission policy associated with the restricted geographic area 205 may apply based on the time component. As an example, an NFZ of the restricted geographic area 205 may apply from 7 am to 9 am or the NFZ may apply for 24 hours as a default. In some examples, the network may indicate each type of area in an area type indication (e.g., NTZ, NFZ, NLZ) (e.g., in the restriction information 215 or a new message). Based on the indication, the UE 115-a may determine performance (e.g., do not enter NFZ, apply NTZ policies, no transmission for NTZ, do not leave for NLZ, and so forth) in the restricted geographic area 205.

In some examples, geofencing information may be provided using an application layer (e.g., by an unmanned aircraft system traffic management (UTM)). In such examples, a network operator may be involved and provide bit-pipe messages or messaging by upper layers (e.g., Non-Access Stratum (NAS) based solutions).

In some examples, the restriction information 215 indicating one or more transmission restriction policies for the restricted geographic area 205 may be signaled by a RAN operator (e.g., via network entity 105-a or via a different network entity, not shown) using dedicated RRC messages (e.g., for UE-specific geofencing for different entities, such as different UEs 115). The RRC reconfiguration messages may include any restriction information for the restricted geographic area 205 that is received in RRC reconfiguration and may apply upon receiving the RRC configuration message. The information may be applicable in a connected mode or in an idle mode (e.g., inactive mode). For example, idle mode may be based on activity specific restrictions, such that the UE 115-a may store the configuration to be used when the UE 115-a is in the idle or inactive mode. The UE 115-a may receive the restricted geographic area 205 in RRC release messages for applicability for the idle or inactive mode. The network entity 105-a may output to the UE 115-a or broadcast (e.g., similar to a warning area) if the RRC restriction information 215 is applicable for multiple UEs 115 (e.g., in a system information block (SIB)).

The restricted geographic area 205 information may be outputted (e.g., transmitted) in a groupcast or multicast message to different groups of UEs 115 using group radio network temporary identifiers (G-RNTIs). In some examples, the restricted geographic area 205 information may be outputted using a new medium access control element (MAC-CE) defined for the restricted geographic area 205. The MAC-CE may indicate the entire restriction information 215 for the restricted geographic area 205, or the MAC-CE may be used for enabling or disabling of the restricted geographic area 205.

In some examples, an indication of the restricted geographic area 205 may be provided using a downlink control information (DCI) for enabling or disabling of the restricted geographic area information for the UE 115-a. The absence of a restricted geographic area 205 may be defined to indicate that there is no restriction. In some examples, the signaling may define or indicate that the UE 115-a may not be allowed to go to an aerial state (e.g., NFZ).

A SIB, dedicated RRC, MAC-CE, or DCI signaling (e.g., from network entity 105-a or from a different network entity, not shown) may be used for in-coverage (e.g., within a threshold distance from a cell). For example, such signaling may provide restriction information 215 for the restricted geographic area 205. However, for out-of-coverage scenarios (e.g., outside of a threshold distance from a cell), the restriction information 215 for the restricted geographic area 205 may be provided before the UE 115-a enters the restricted geographic area (e.g., at application layer and stored in the UE, provided using direct communications (PC5) sidelink by other UAVs which are able to retrieve the restriction information 215 from the network, and the like).

The restriction information 215 for the restricted geographic area 205 may be provided via signaling using a SIB, and such signaling may provide geographic coordinates of a polygon defining the restricted geographic area 205. For example, an AreaCoordinatesSegment in the signaling may carry a segment, with one or more octets, providing geographic coordinates of a polygon defining the restricted geographic area 205 where the restriction information 215 (e.g., transmission restriction policy) is valid. Similar segments may be used in the signaling for restriction information 215 for a restricted geographic area 205.

New control signaling, such as a new SIB, may be added to SIB signaling to indicate the restricted geographic area 205. For example, the SIB may include an indication of geofencing information (including the x, y, z coordinates), as well as an indication of the area type (e.g., NTZ for the restricted geographic area 205). For example, NTZ information (e.g., restriction information 215 indicating one or more transmission restriction policies for a restricted geographic area 205 that is an NTZ) may indicate, for example, one or more of an indication that the NTZ zone implicitly applies to a current serving frequency, other frequencies over which transmissions are restricted in the restricted geographic area 205, frequencies over which transmissions are permitted, or any combination thereof. In some examples, the NTZ information may indicate one or more restricted transmission limits (e.g., non-zero transmit power permitted but limited in the zone).

In some example, the UE 115-a may be capable of understanding and complying with an indicated restricted geographic area 205 based on a version of the UE 115-a. For example, a current or recent version of the UE 115-a (e.g., generation of UE 115 produced after a particular year or complying with a particular version of a wireless communication standard) may be capable of processing the signaling indicating the restricted geographic area 205 while earlier versions of the UE 115-a are not capable. For example, a UE 115-a complying with a particular version may be expected to know geofenced boundaries (e.g., 2D or 3D) while an older version (e.g., complying with an older version of a standard) may not understand the geofenced boundaries for NTZ/NFZ/NLZ.

In some examples, for the older version of the UE 115 (e.g., first UE) to not attach to the cells covering NTZ or NFZ area (e.g., partially or completely), a new barring bit may be used to indicate to the first UE 115 that the cell is barred (e.g., that the first UE is not permitted to establish connectivity with that cell). Another specific barring bit may be used for a second UE 115-a (e.g., that complies with a later version of a standard) to indicate that the cell is not barred (e.g., that the second UE is permitted to establish connectivity with the cell). However, barring the cell for all the older versions of the UE 115 may also bar UEs 115 from using the cell that may otherwise be intended to use the cell (e.g., terrestrial UEs 115).

Accordingly, in some examples, network signaling (NS) fields for indicating additional spectrum emission values may be used in a SIB (e.g., SIB1) to cause the older version of the UEs 115 to disregard the values provided in the SIB. For example, one or more aerial specific NS value (also known as additional spectrum emission value) fields in the SIB may be broadcasted using NS values that are reserved for the newer UEs 115 and that are not supported by the older version UEs 115. Therefore, a frequency indicated in the aerial specific NS value fields in the SIB is disregarded by the previous version UEs 115. In some examples, NS field values for current UEs 115 may be added to the SIB and may be used when the current UE 115 is within an NTZ boundary (e.g., since the signaling may provide the boundaries, the UE 115 may consider the cell not usable when within the boundary and usable outside the boundary). In an idle mode, the current UEs 115 may receive SIB1 and/or SIB2 and/or other SIBs, and may apply the NS accordingly at the time of initial access.

For connected mode, for example, during a handover procedure, a source cell may be aware of a restricted geographic area 205 (e.g., NTZ) in a target area. If the source cell is already aware of the frequencies associated with the restricted geographic area 205 in the target network entity 105, the source cell may exclude such frequencies from the potential target cells. Accordingly, a cell may notify neighboring cells about respective restriction information 215 associated with the cell. Cells with restriction information may share, provide, or forward the information to the neighbors (e.g., using Xn and next-generation application protocol).

As part of conditional handover (CHO) or L1/L2 triggered mobility (LTM), NTZ information and capabilities as indicated from another cell may be considered by the source cell to prepare preferred target handover candidates and/or order of the CHO or LTM configuration parameters. If the source cell is not already aware of the target cell NTZ area but is capable of handling NTZ (e.g., current version), the target cell may inform the source during the handover preparation phase about the NTZ and permit a UE 115 to communicate over the associated allowed frequency. If no frequencies are permitted, the target candidate cell may send a handover failure. In some examples, new handover failure causes may be defined. For example, a target cell may send a message to the source cell with the new handover failure cause in the handover preparation failure message.

In a connected mode, such as during a handover procedure, a source cell associated with an older version (e.g., is not capable of receiving or processing signaling for restriction information, such as NTZ information) may target a cell associated with the current version that is capable of receiving and processing the restriction information 215. In such examples, the source cell may provide the UE 115-a (e.g., a current version cell that implements NS field-based backward compatible solution) with a SIB1 in order to handover a UE 115-a in a handover command. The UE 115 may apply the target SIB1 information. However, if the UE 115-a is handed over to a cell with frequency that is not permitted for uplink in that restricted geographic area 205, then the UE 115-a may not send a handover complete message to the source cell, resulting in a handover failure. The handover procedures discussed herein may apply to a Xn-based handover, a Next Generation Application Protocol (NGAP)-based handover, or the like. In some examples, a new cause value may be defined for a handover failure, and the value may be sent to the source cell in the handover preparation failure. In some examples, the techniques discussed herein may involve RRC signaling indicating the restricted geographic area 205 (e.g., in SIB1), a new MAC-CE defined to include restriction information 215 (e.g., coordinates, area type indicator, or transmission restriction policy) for a restricted geographic area 205 to indicate to the current UEs 115.

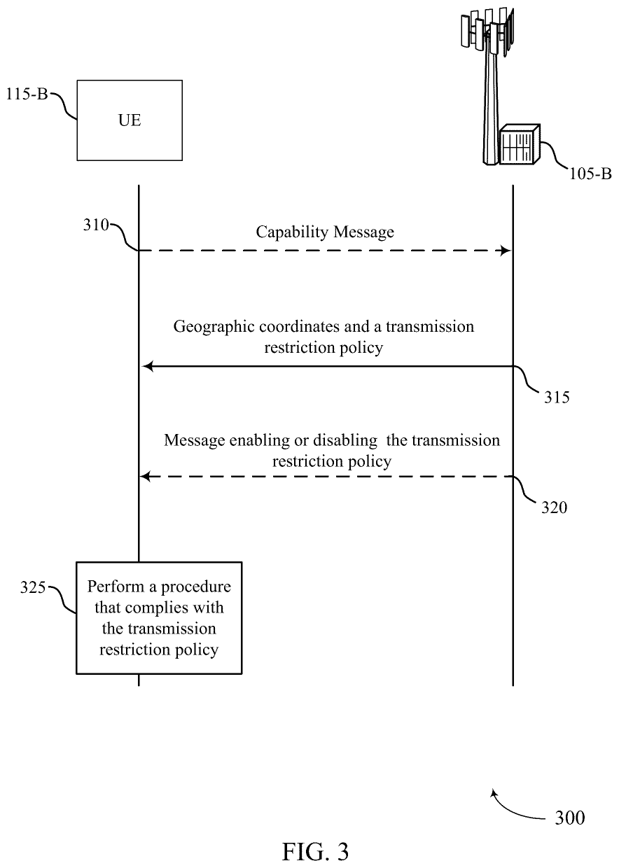

FIG. 3 shows an example of a process flow 300 that supports coordinate signaling for a restricted geographic area in accordance with one or more aspects of the present disclosure. The process flow 300 may implement aspects of wireless communications system 100 or a wireless communications system 200. For instance, the process flow 300 may illustrate operations between a UE 115-b and a network entity 105-b, which may be respective examples of a UE 115 and a network entity 105 described herein. In the following description of the process flow 300, the operations between the UE 115-b and the network entity 105-b be performed in different orders or at different times than described. Some operations also may be omitted from the process flow 300, and other operations may be added to the process flow 300.

In some examples, at 310, the UE 115-b may transmit an indication of a capability of the UE 115-b. The capability may indicate whether the UE 115-b may support signaling for a restricted geographic area. At 315, the UE 115-b may receive one or more messages indicating geographic coordinates of a restricted geographic area. The geographic coordinates may correspond to one or more boundaries of a polygon that defines an area or a volume of the restricted geographic area. The area type indicator may indicate that the restricted geographic area is an NFZ, an NTZ (e.g., no uplink transmission zone), or an NLZ (e.g., no departure zone). The one or more messages may further indicate a transmission restriction policy associated with the restricted geographic area. In some examples, UE 115-b may receive one or more messages indicating an area type indicator for the restricted geographic are. The area type indicator may indicate that the restricted geographic area is an NFZ, an NTZ (e.g., no uplink transmission zone), or an NLZ (e.g., no departure zone).

The one or more messages may indicate a time period during which the transmission restriction policy applies. In some examples, at 320, the UE 115-b may receive a control message that enables or disables the transmission restriction policy for the restricted geographic area. The transmission restriction policy may indicate a restriction prohibiting transmission using at least a first frequency band within the restricted geographic area, permits transmission using a second frequency band within the restricted geographic area, or both.

In some examples, the UE 115-b receiving the one or more messages indicating geographic coordinates may include receiving a RRC message, a SIB, a DCI message, or a MAC-CE message, based on the UE 115-b being disposed inside of a coverage area associated with the network entity 105-b. To receive the one or more messages, the UE 115-b may receive one or more application layer messages or one or more sidelink messages based on the UE 115-b being disposed outside of a coverage area associated with the network entity 105-b. Receiving the one or more messages indicating geographic coordinates may include receiving a bit field including a barring bit indicating whether establishing connectivity with a cell within the restricted geographic area is barred. Receiving one or more messages indicating geographic coordinates may include receiving a NS field including a value indicating that establishing connectivity with a cell is permitted when the UE 115-b is located outside of the restricted geographic area and that establishing connectivity with the cell is not permitted when the UE 115-b is located within the restricted geographic area. The NS field may include a first network signaling value indicating an area type or a second network signaling value indicating the geographic coordinates.

At 325, the UE 115-b may perform a procedure that complies with the transmission restriction policy based on a current geolocation of the UE relative to the geographic coordinates corresponding to the one or more boundaries of the polygon associated with the restricted geographic area. In some examples, performing the procedure may include the UE 115-b transmitting a first message in accordance with the transmission power limit. In some examples, performing the procedure may also include refraining from transmitting a transmission within the restricted geographic area, maintaining the UE 115-b within the restricted geographic area, staying within the restricted geographic area, transmitting using only one or more selected radio frequency channels while refraining from transmitting using one or more other radio frequency channels, as well as other operations described herein in accordance with one or more transmission restriction policies (e.g., NTZ information, restricted information, etc.).

In some examples, the network entity 105-b may generate one or more messages indicating the geographic coordinates of the restricted geographic area and the area type indicator for the restricted geographic area. The geographic coordinates may correspond to one or more boundaries of a polygon that defines the area or the volume of the restricted geographic area. The area type indicator may indicate that the restricted geographic area is a NFZ, an NTZ, or an NLZ. The area type indicator may further indicate the transmission restriction policy associated with the restricted geographic area. The network entity 105-b may output the one or more messages to the UE 115-b. In some examples, the network entity 105-b may output, during a handover procedure, an indication of the area type indicator and the transmission restriction policy associated with the restricted geographic area, to a handover candidate network entity (e.g., another network entity 105 different than the network entity 105-b). The network entity 105-b may obtain an indication an area type capability associated with the handover candidate network entity. Transmitting the indication of the area type indicator and the transmission restriction policy is based on the area type capability associated with the handover candidate network entity 105. The network entity 105-b may obtain, during the handover procedure, an indication of handover failure based at on the area type capability being incompatible with the transmission restriction policy associated with the area type.

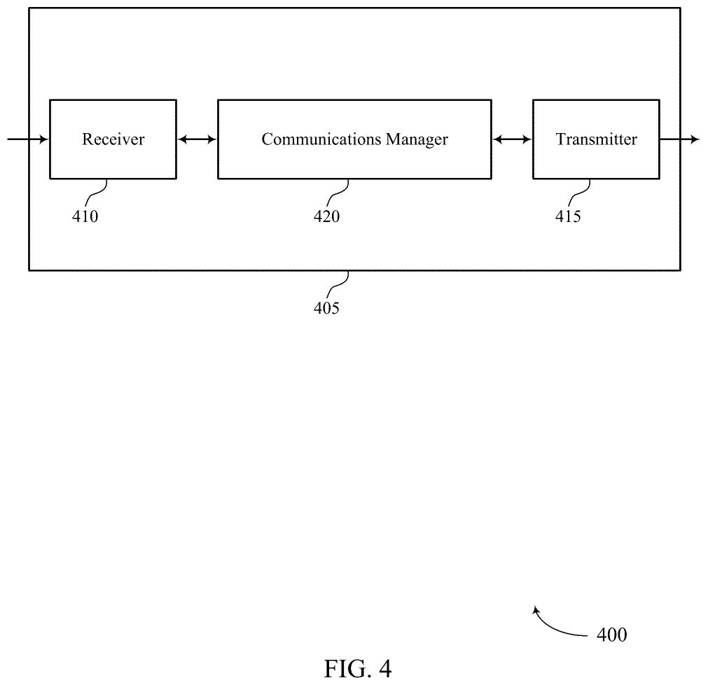

FIG. 4 shows a block diagram 400 of a device 405 that supports coordinate signaling for a restricted geographic area in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to coordinate signaling for a restricted geographic area). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to coordinate signaling for a restricted geographic area). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of coordinate signaling for a restricted geographic area as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area. The communications manager 420 is capable of, configured to, or operable to support a means for performing a procedure that complies with the transmission restriction policy based on a current geolocation of the UE relative to the geographic coordinates corresponding to the one or more boundaries of the polygon associated with the restricted geographic area.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for efficiently signaling transmission policies to UEs 115 within restricted geographic areas, where the UEs are current and older generation models.

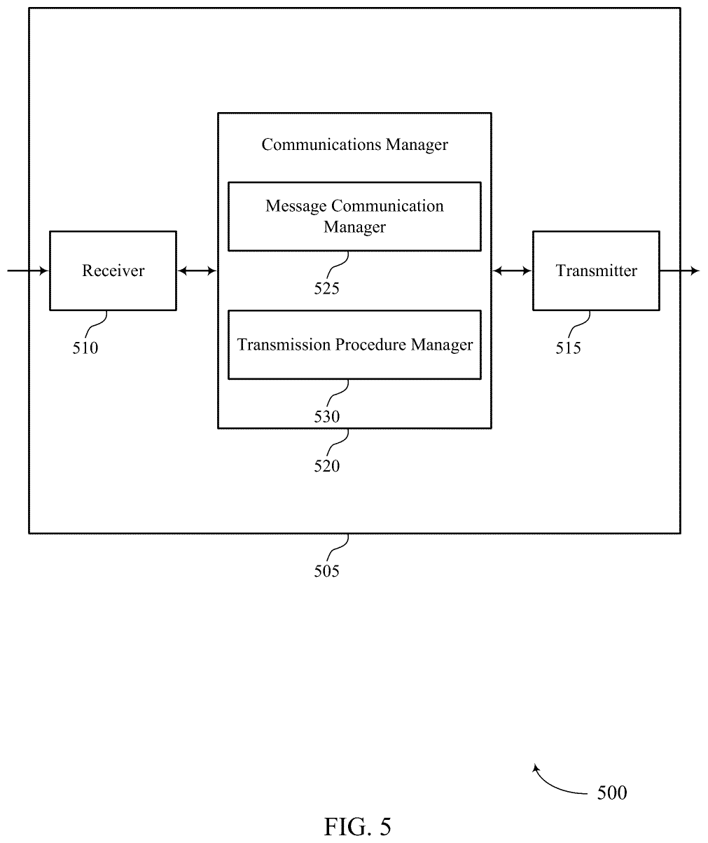

FIG. 5 shows a block diagram 500 of a device 505 that supports coordinate signaling for a restricted geographic area in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to coordinate signaling for a restricted geographic area). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to coordinate signaling for a restricted geographic area). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of coordinate signaling for a restricted geographic area as described herein. For example, the communications manager 520 may include a message communication manager 525 a transmission procedure manager 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The message communication manager 525 is capable of, configured to, or operable to support a means for receiving one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area. The transmission procedure manager 530 is capable of, configured to, or operable to support a means for performing a procedure that complies with the transmission restriction policy based on a current geolocation of the UE relative to the geographic coordinates corresponding to the one or more boundaries of the polygon associated with the restricted geographic area.

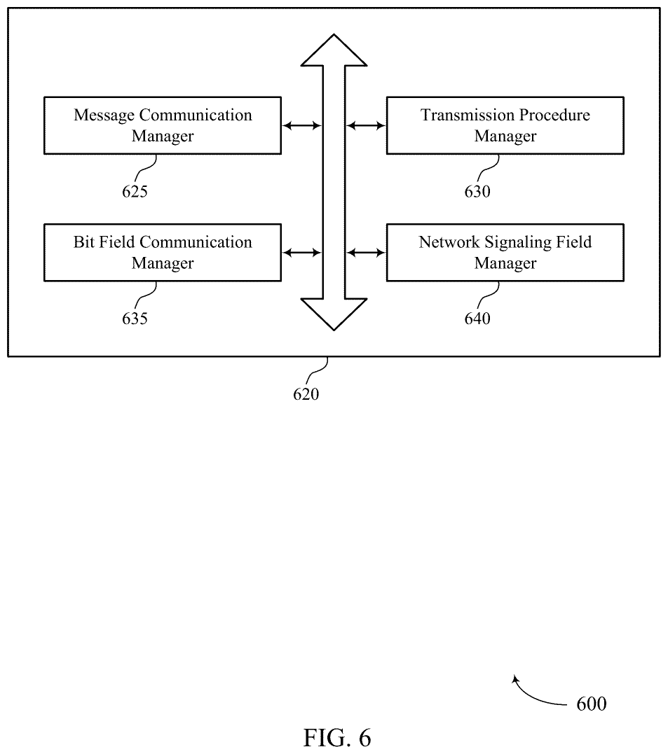

FIG. 6 shows a block diagram 600 of a communications manager 620 that supports coordinate signaling for a restricted geographic area in accordance with one or more aspects of the present disclosure. The communications manager 620 may be an example of aspects of a communications manager 420, a communications manager 520, or both, as described herein. The communications manager 620, or various components thereof, may be an example of means for performing various aspects of coordinate signaling for a restricted geographic area as described herein. For example, the communications manager 620 may include a message communication manager 625, a transmission procedure manager 630, a bit field communication manager 635, a network signaling field manager 640, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The message communication manager 625 is capable of, configured to, or operable to support a means for receiving one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area. The transmission procedure manager 630 is capable of, configured to, or operable to support a means for performing a procedure that complies with the transmission restriction policy based on a current geolocation of the UE relative to the geographic coordinates corresponding to the one or more boundaries of the polygon associated with the restricted geographic area.

In some examples, the message communication manager 625 is capable of, configured to, or operable to support a means for receiving one or more messages indicating an area type indicator. The area type indicator may indicate that the restricted geographic area is an NFZ, an NTZ (e.g., no uplink transmission zone), or an NLZ (e.g., no departure zone).

In some examples, receiving the one or more messages indicating the geographic coordinates is based on a capability of the UE.

In some examples, the one or more messages indicates a time period during which the transmission restriction policy applies.

In some examples, the message communication manager 625 is capable of, configured to, or operable to support a means for receiving a control message that enables or disables the transmission restriction policy for the restricted geographic area.

In some examples, the transmission restriction policy indicates a restriction prohibiting transmission using at least a first frequency band within the restricted geographic area, permits transmission using a second frequency band within the restricted geographic area, or both.

In some examples, to support performing the procedure, the message communication manager 625 is capable of, configured to, or operable to support a means for transmitting a first message in accordance with the transmission power limit.

In some examples, to support receiving the one or more messages, the message communication manager 625 is capable of, configured to, or operable to support a means for receiving a RRC message, a SIB, a DCI message, or a MAC-CE message, based on the UE being disposed inside of a coverage area associated with a network entity.

In some examples, to support receiving the one or more messages, the message communication manager 625 is capable of, configured to, or operable to support a means for receiving one or more application layer messages or one or more sidelink messages based on the UE being disposed outside of a coverage area associated with a network entity.

In some examples, to support receiving the one or more messages, the bit field communication manager 635 is capable of, configured to, or operable to support a means for receiving a bit field including a barring bit indicating whether establishing connectivity with a cell within the restricted geographic area is barred.

In some examples, to support receiving the one or more messages, the network signaling field manager 640 is capable of, configured to, or operable to support a means for receiving a network signaling field including a value indicating that establishing connectivity with a cell is permitted when the UE is located outside of the restricted geographic area and that establishing connectivity with the cell is not permitted when the UE is located within the restricted geographic area.

In some examples, the network signaling field includes a first network signaling value indicating an area type or a second network signaling value indicating the geographic coordinates.

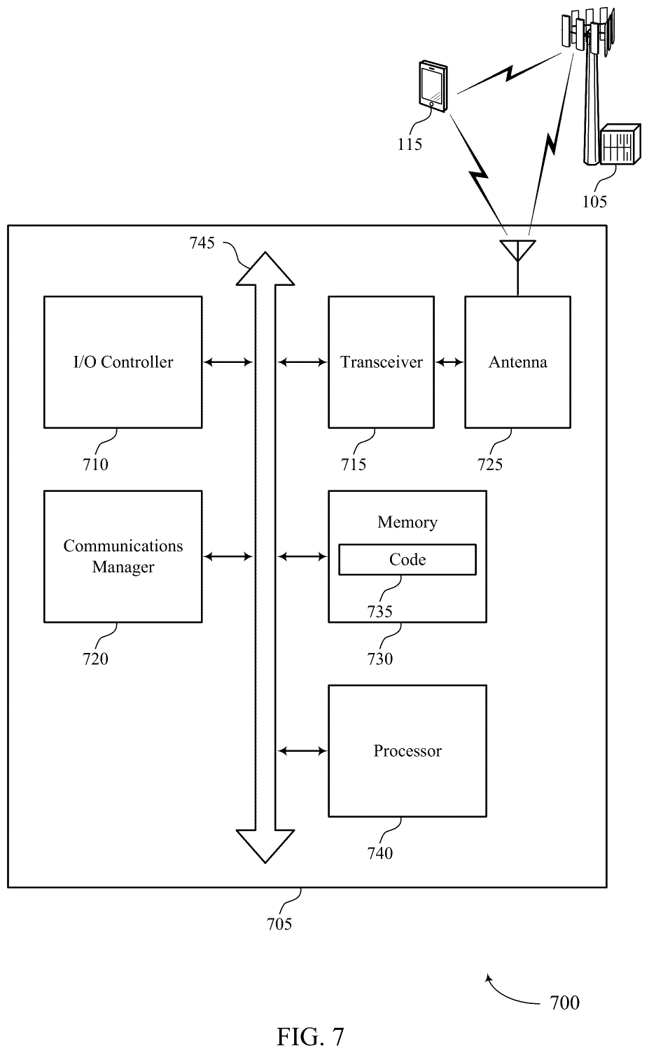

FIG. 7 shows a diagram of a system 700 including a device 705 that supports coordinate signaling for a restricted geographic area in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting coordinate signaling for a restricted geographic area). For example, the device 705 or a component of the device 705 may include at least one processor 740 and at least one memory 730 coupled with or to the at least one processor 740, the at least one processor 740 and the at least one memory 730 configured to perform various functions described herein. In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area. The communications manager 720 is capable of, configured to, or operable to support a means for performing a procedure that complies with the transmission restriction policy based on a current geolocation of the UE relative to the geographic coordinates corresponding to the one or more boundaries of the polygon associated with the restricted geographic area.

By including or configuring the communications manager 720 in accordance with examples as described herein, the device 705 may support techniques for efficiently signaling transmission policies to UEs 115 within restricted geographic areas, where the UEs 115 may be current and/or older generation models.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of coordinate signaling for a restricted geographic area as described herein, or the at least one processor 740 and the at least one memory 730 may be otherwise configured to, individually or collectively, perform or support such operations.

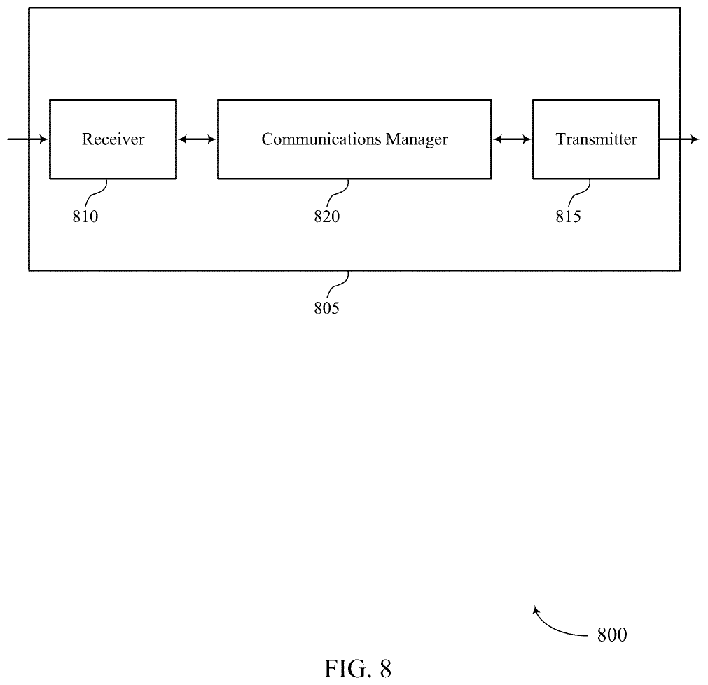

FIG. 8 shows a block diagram 800 of a device 805 that supports coordinate signaling for a restricted geographic area in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of coordinate signaling for a restricted geographic area as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for generating one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area. The communications manager 820 is capable of, configured to, or operable to support a means for outputting the one or more messages to a UE, such as an aerial UE.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for efficiently signaling transmission policies to UEs 115 within restricted geographic areas, where the UEs 115 may be current and/or older generation models.

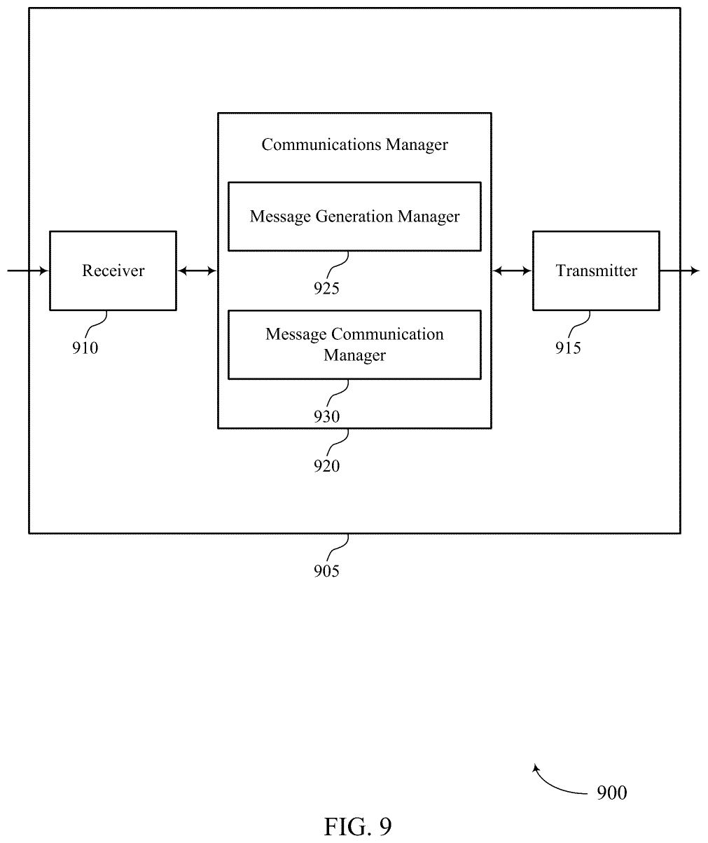

FIG. 9 shows a block diagram 900 of a device 905 that supports coordinate signaling for a restricted geographic area in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of coordinate signaling for a restricted geographic area as described herein. For example, the communications manager 920 may include a message generation manager 925 a message communication manager 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The message generation manager 925 is capable of, configured to, or operable to support a means for generating one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area. The message communication manager 930 is capable of, configured to, or operable to support a means for outputting the one or more messages to a UE, such as an aerial UE.

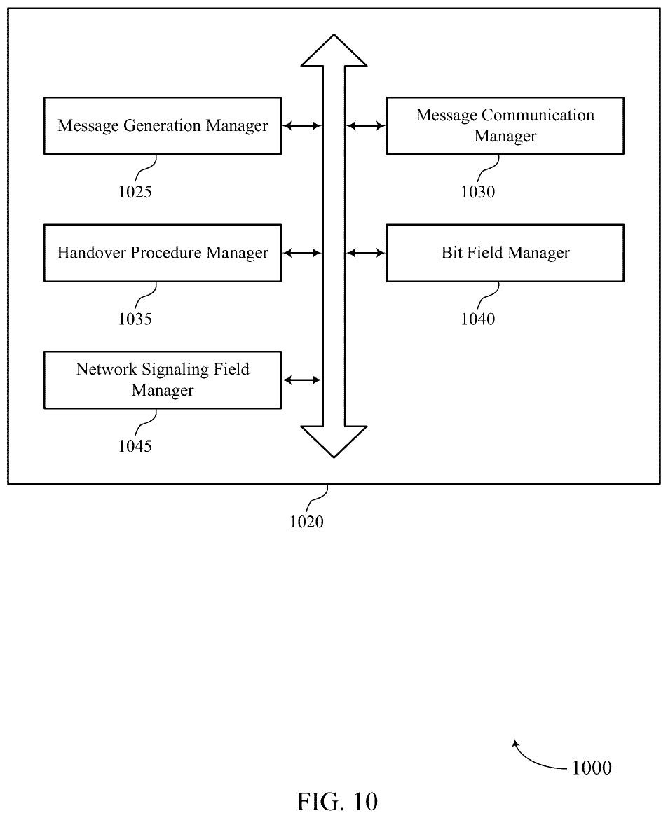

FIG. 10 shows a block diagram 1000 of a communications manager 1020 that supports coordinate signaling for a restricted geographic area in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of coordinate signaling for a restricted geographic area as described herein. For example, the communications manager 1020 may include a message generation manager 1025, a message communication manager 1030, a handover procedure manager 1035, a bit field manager 1040, a network signaling field manager 1045, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The message generation manager 1025 is capable of, configured to, or operable to support a means for generating one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area. The message communication manager 1030 is capable of, configured to, or operable to support a means for outputting the one or more messages to a UE, such as an aerial UE.

In some examples, the handover procedure manager 1035 is capable of, configured to, or operable to support a means for outputting, during a handover procedure, an indication of the area type indicator and the transmission restriction policy associated with the restricted geographic area, to a handover candidate network entity.

In some examples, the handover procedure manager 1035 is capable of, configured to, or operable to support a means for obtaining an indication an area type capability associated with the handover candidate network entity, where transmitting the indication of the area type indicator and the transmission restriction policy is based on the area type capability associated with the handover candidate network entity.

In some examples, the handover procedure manager 1035 is capable of, configured to, or operable to support a means for obtaining, during the handover procedure, an indication of handover failure based on the area type capability being incompatible with the transmission restriction policy associated with the area type.

In some examples, outputting the one or more messages indicating the geographic coordinates is based on a capability of the UE.

In some examples, the one or more messages indicates a time period during which the transmission restriction policy applies.

In some examples, the message communication manager 1030 is capable of, configured to, or operable to support a means for outputting a control message that enables or disables the transmission restriction policy for the restricted geographic area.

In some examples, the transmission restriction policy indicates a restriction prohibiting transmission using at least a first frequency band within the restricted geographic area, permits transmission using a second frequency band within the restricted geographic area, or both.

In some examples, the transmission restriction policy indicates a transmission power limit for transmissions within the restricted geographic area.

In some examples, to support outputting the one or more messages, the message communication manager 1030 is capable of, configured to, or operable to support a means for outputting a RRC message, a SIB, a DCI message, or a MAC-CE message, based on the UE being disposed inside of a coverage area associated with a network entity.

In some examples, to support outputting the one or more messages, the message communication manager 1030 is capable of, configured to, or operable to support a means for outputting one or more application layer messages or one or more sidelink messages based on the UE being disposed outside of a coverage area associated with a network entity.

In some examples, to support outputting the one or more messages, the bit field manager 1040 is capable of, configured to, or operable to support a means for outputting a bit field including a barring bit indicating whether establishing connectivity with a cell within the restricted geographic area is barred.

In some examples, to support outputting the one or more messages, the network signaling field manager 1045 is capable of, configured to, or operable to support a means for outputting a network signaling field including a value indicating that establishing connectivity with a cell is permitted when the UE is located outside of the restricted geographic area and that establishing connectivity with the cell is not permitted when the UE is located within the restricted geographic area.

In some examples, the network signaling field includes a first network signaling value indicating an area type or a second network signaling value indicating the geographic coordinates.

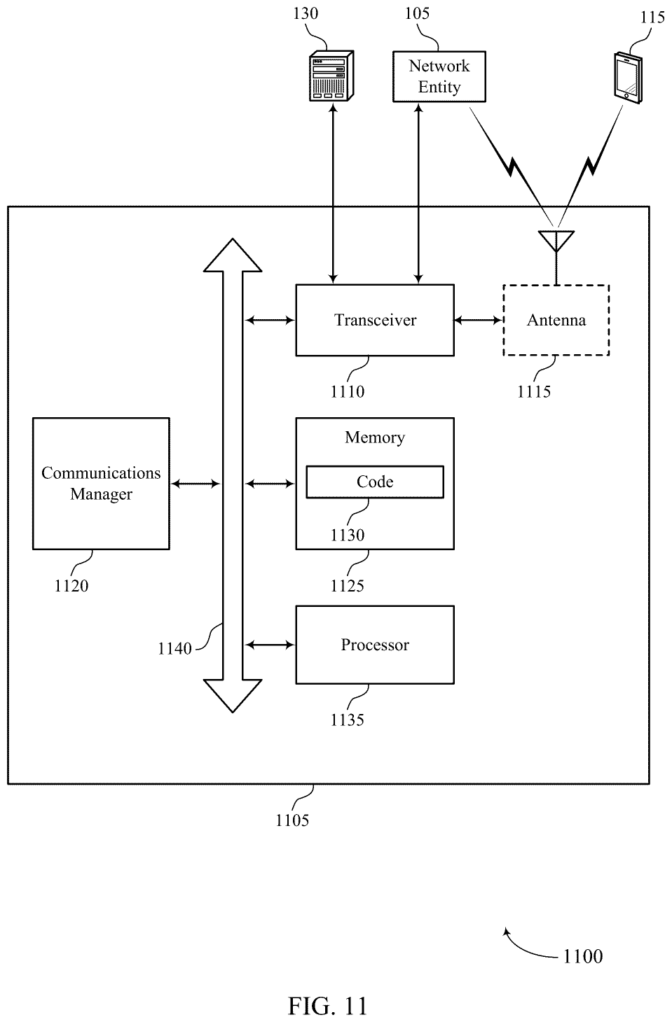

FIG. 11 shows a diagram of a system 1100 including a device 1105 that supports coordinate signaling for a restricted geographic area in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting coordinate signaling for a restricted geographic area). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network devices, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for generating one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area. The communications manager 1120 is capable of, configured to, or operable to support a means for outputting the one or more messages to a UE, such as an aerial UE.

By including or configuring the communications manager 1120 in accordance with examples as described herein, the device 1105 may support techniques for efficiently signaling transmission policies to UEs 115 within restricted geographic areas, where the UEs 115 may be current and/or older generation models.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of coordinate signaling for a restricted geographic area as described herein, or the at least one processor 1135 and the at least one memory 1125 may be otherwise configured to, individually or collectively, perform or support such operations.

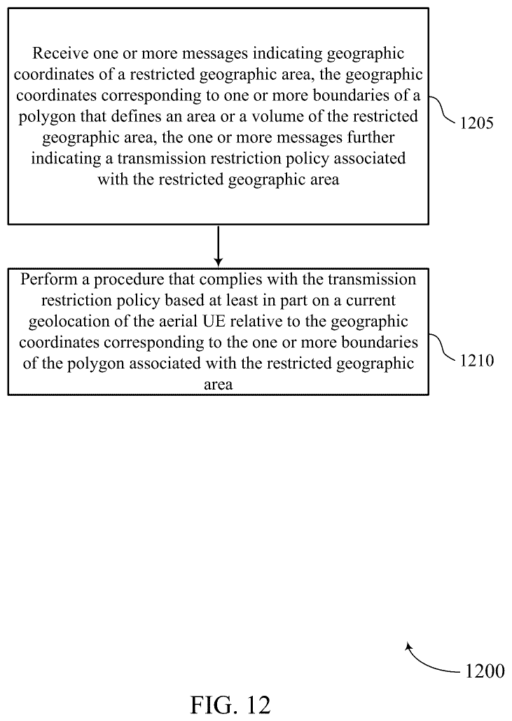

FIG. 12 shows a flowchart illustrating a method 1200 that supports coordinate signaling for a restricted geographic area in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area. The operations of 1205 may be performed in accordance with examples as disclosed herein. In some examples, aspects of the operations of 1205 may be performed by a message communication manager 625 as described with reference to FIG. 6.

At 1210, the method may include performing a procedure that complies with the transmission restriction policy based at least in part on a current geolocation of the UE relative to the geographic coordinates corresponding to the one or more boundaries of the polygon associated with the restricted geographic area. The operations of 1210 may be performed in accordance with examples as disclosed herein. In some examples, aspects of the operations of 1210 may be performed by a transmission procedure manager 630 as described with reference to FIG. 6.

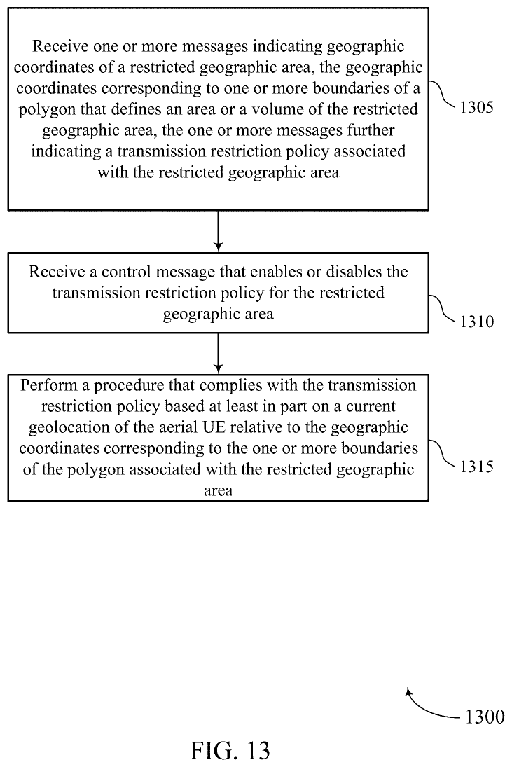

FIG. 13 shows a flowchart illustrating a method 1300 that supports coordinate signaling for a restricted geographic area in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include receiving one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area. The operations of 1305 may be performed in accordance with examples as disclosed herein. In some examples, aspects of the operations of 1305 may be performed by a message communication manager 625 as described with reference to FIG. 6.

At 1310, the method may include receiving a control message that enables or disables the transmission restriction policy for the restricted geographic area. The operations of 1310 may be performed in accordance with examples as disclosed herein. In some examples, aspects of the operations of 1310 may be performed by a message communication manager 625 as described with reference to FIG. 6.

At 1315, the method may include performing a procedure that complies with the transmission restriction policy based at least in part on a current geolocation of the UE relative to the geographic coordinates corresponding to the one or more boundaries of the polygon associated with the restricted geographic area. The operations of 1315 may be performed in accordance with examples as disclosed herein. In some examples, aspects of the operations of 1315 may be performed by a transmission procedure manager 630 as described with reference to FIG. 6.

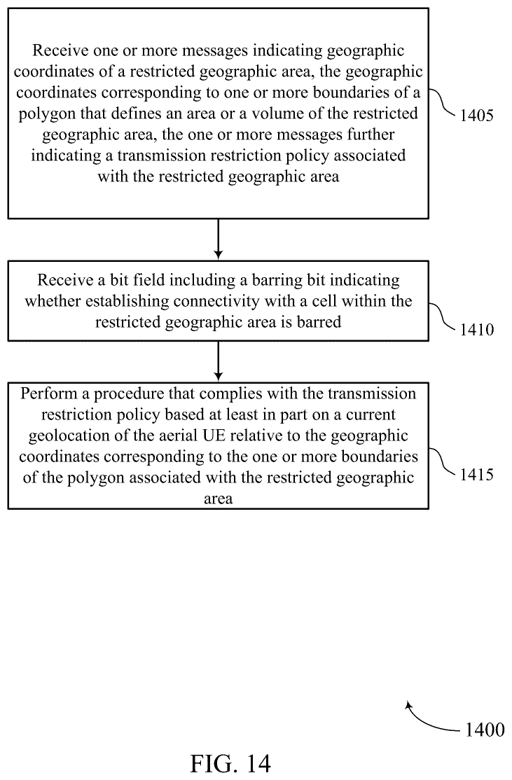

FIG. 14 shows a flowchart illustrating a method 1400 that supports coordinate signaling for a restricted geographic area in accordance with one or more aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include receiving one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area. The operations of 1405 may be performed in accordance with examples as disclosed herein. In some examples, aspects of the operations of 1405 may be performed by a message communication manager 625 as described with reference to FIG. 6.

At 1410, the method may include receiving a bit field including a barring bit indicating whether establishing connectivity with a cell within the restricted geographic area is barred. The operations of 1410 may be performed in accordance with examples as disclosed herein. In some examples, aspects of the operations of 1410 may be performed by a bit field communication manager 635 as described with reference to FIG. 6.

At 1415, the method may include performing a procedure that complies with the transmission restriction policy based at least in part on a current geolocation of the UE relative to the geographic coordinates corresponding to the one or more boundaries of the polygon associated with the restricted geographic area. The operations of 1415 may be performed in accordance with examples as disclosed herein. In some examples, aspects of the operations of 1415 may be performed by a transmission procedure manager 630 as described with reference to FIG. 6.

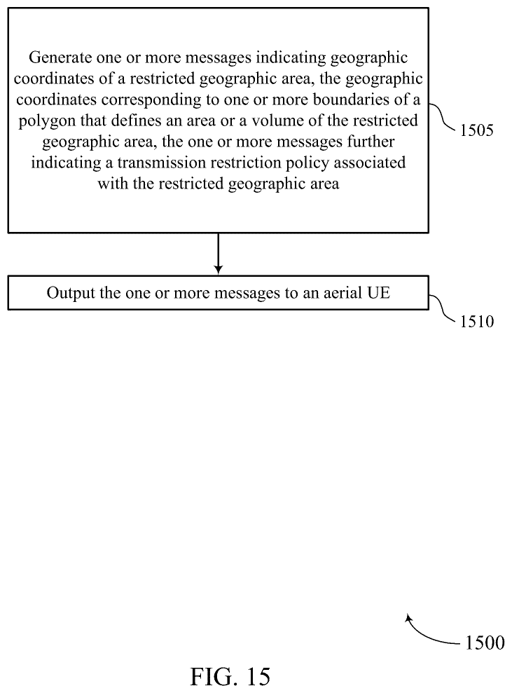

FIG. 15 shows a flowchart illustrating a method 1500 that supports coordinate signaling for a restricted geographic area in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include generating one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area. The operations of 1505 may be performed in accordance with examples as disclosed herein. In some examples, aspects of the operations of 1505 may be performed by a message generation manager 1025 as described with reference to FIG. 10.

At 1510, the method may include outputting the one or more messages to a UE, such as an aerial UE. The operations of 1510 may be performed in accordance with examples as disclosed herein. In some examples, aspects of the operations of 1510 may be performed by a message communication manager 1030 as described with reference to FIG. 10.

The following provides an overview of aspects of the present disclosure:

Aspect 1: A method for wireless communications at a UE, comprising: receiving one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area; and performing a procedure that complies with the transmission restriction policy based at least in part on a current geolocation of the UE relative to the geographic coordinates corresponding to the one or more boundaries of the polygon associated with the restricted geographic area.

Aspect 2: The method of aspect 1, further comprising: receiving one or more messages indicating an area type indicator for the restricted geographic area, the area type indicator indicating that the restricted geographic area is a no fly zone, a no uplink transmission zone, or a no departure zone.

Aspect 3: The method of any of aspects 1 through 2, wherein receiving the one or more messages indicating the geographic coordinates is based at least in part on a capability of the UE.

Aspect 4: The method of any of aspects 1 through 3, wherein the one or more messages indicates: the geographic coordinates of the restricted geographic area and at least one frequency band associated with the restricted geographic area; or the geographic coordinates of the restricted geographic area, the at least one frequency band associated with the restricted geographic area and a time period during which the transmission restriction policy applies.

Aspect 5: The method of any of aspects 1 through 4, further comprising: receiving a control message that enables or disables the transmission restriction policy for the restricted geographic area.

Aspect 6: The method of any of aspects 1 through 5, wherein the transmission restriction policy indicates a restriction prohibiting transmission using at least a first frequency band within the restricted geographic area, permits transmission using a second frequency band within the restricted geographic area, or both.

Aspect 7: The method of any of aspects 1 through 6, wherein the transmission restriction policy indicates a transmission power limit for transmissions within the restricted geographic area, wherein performing the procedure comprises: transmitting a first message in accordance with the transmission power limit.

Aspect 8: The method of any of aspects 1 through 7, wherein receiving the one or more messages further comprises: receiving a RRC message, a SIB, a DCI message, or a MAC-CE message, based at least in part on the UE being disposed inside of a coverage area associated with a network entity.

Aspect 9: The method of any of aspects 1 through 8, wherein receiving the one or more messages further comprises: receiving one or more application layer messages or one or more sidelink messages based at least in part on the UE being disposed outside of a coverage area associated with a network entity.

Aspect 10: The method of any of aspects 1 through 9, wherein receiving the one or more messages further comprises: receiving a bit field comprising a barring bit indicating whether establishing connectivity with a cell within the restricted geographic area is barred.

Aspect 11: The method of any of aspects 1 through 10, wherein receiving the one or more messages further comprises: receiving a network signaling field comprising a value indicating that establishing connectivity with a cell is permitted when the UE is located outside of the restricted geographic area and that establishing connectivity with the cell is not permitted when the aerial UE is located within the restricted geographic area.

Aspect 12: The method of aspect 11, wherein the network signaling field comprises a first network signaling value indicating an area type, a second network signaling value indicating the geographic coordinates, or both, or wherein the geographic coordinates are associated with an altitude for the restricted geographic area.

Aspect 13: The method of any of aspects 1 through 12, wherein receiving the one or more messages further comprises: receiving signaling indicating that transmission is barred in the restricted geographic area or indicating permission to transmit in accordance with the transmission restriction policy in the restricted geographic area.

Aspect 14: A method for wireless communications at a network entity, comprising: generating one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area; and outputting the one or more messages to a UE.

Aspect 15: The method of aspect 14, further comprising: outputting, during a handover procedure, an indication of the area type indicator and the transmission restriction policy associated with the restricted geographic area, to a handover candidate network entity.

Aspect 16: The method of aspect 15, further comprising: obtaining an indication an area type capability associated with the handover candidate network entity, wherein transmitting the indication of the area type indicator and the transmission restriction policy is based at least in part on the area type capability associated with the handover candidate network entity.

Aspect 17: The method of aspect 16, further comprising: obtaining, during the handover procedure, an indication of handover failure based at least in part on the area type capability being incompatible with the transmission restriction policy associated with the area type.

Aspect 18: The method of any of aspects 14 through 17, wherein outputting the one or more messages indicating the geographic coordinates is based at least in part on a capability of the UE.

Aspect 19: The method of any of aspects 14 through 18, wherein the one or more messages indicates: the geographic coordinates of the restricted geographic area and at least one frequency band associated with the restricted geographic area; or the geographic coordinates of the restricted geographic area, the at least one frequency band associated with the restricted geographic area and a time period during which the transmission restriction policy applies.

Aspect 20: The method of any of aspects 14 through 19, further comprising: outputting a control message that enables or disables the transmission restriction policy for the restricted geographic area.

Aspect 21: The method of any of aspects 14 through 20, wherein the transmission restriction policy indicates a restriction prohibiting transmission using at least a first frequency band within the restricted geographic area, permits transmission using a second frequency band within the restricted geographic area, or both.

Aspect 22: The method of any of aspects 14 through 21, wherein the transmission restriction policy indicates a transmission power limit for transmissions within the restricted geographic area.

Aspect 23: The method of any of aspects 14 through 22, wherein outputting the one or more messages further comprises: outputting a RRC message, a SIB, a DCI message, or a MAC-CE message, based at least in part on the UE being disposed inside of a coverage area associated with a network entity.

Aspect 24: The method of any of aspects 14 through 23, wherein outputting the one or more messages further comprises: outputting one or more application layer messages or one or more sidelink messages based at least in part on the UE being disposed outside of a coverage area associated with a network entity.

Aspect 25: The method of any of aspects 14 through 24, wherein outputting the one or more messages further comprises: outputting a bit field comprising a barring bit indicating whether establishing connectivity with a cell within the restricted geographic area is barred.

Aspect 26: The method of any of aspects 14 through 25, wherein outputting the one or more messages further comprises: outputting a network signaling field comprising a value indicating that establishing connectivity with a cell is permitted when the UE is located outside of the restricted geographic area and that establishing connectivity with the cell is not permitted when the UE is located within the restricted geographic area.

Aspect 27: The method of aspect 26, wherein the network signaling field comprises a first network signaling value indicating an area type or a second network signaling value indicating the geographic coordinates or wherein the geographic coordinates are associated with an altitude for the restricted geographic area.

Aspect 28: The method of any of aspects 14 through 27, further comprising: outputting one or more messages indicating an area type indicator for the restricted geographic area, the area type indicator indicating that the restricted geographic area is a no fly zone, a no uplink transmission zone, or a no departure zone.

Aspect 29: The method of any of aspects 14 through 28, further comprising: outputting signaling indicating that transmission is barred in the restricted geographic area or indicating permission to transmit in accordance with the transmission restriction policy in the restricted geographic area

Aspect 30: A UE for wireless communications, comprising one or more memories storing processor-executable code, and one or more processors coupled with the one or more memories and individually or collectively operable to execute the code to cause the UE to perform a method of any of aspects 1 through 13.

Aspect 31: A UE for wireless communications, comprising at least one means for performing a method of any of aspects 1 through 13.

Aspect 32: A non-transitory computer-readable medium storing code for wireless communications, the code comprising instructions executable by one or more processors to perform a method of any of aspects 1 through 13.

Aspect 33: A network entity for wireless communications, comprising one or more memories storing processor-executable code, and one or more processors coupled with the one or more memories and individually or collectively operable to execute the code to cause the network entity to perform a method of any of aspects 14 through 29.

Aspect 34: A network entity for wireless communications, comprising at least one means for performing a method of any of aspects 14 through 29.

Aspect 35: A non-transitory computer-readable medium storing code for wireless communications, the code comprising instructions executable by one or more processors to perform a method of any of aspects 14 through 29.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area; and
perform a procedure that complies with the transmission restriction policy based at least in part on a current geolocation of the UE relative to the geographic coordinates corresponding to the one or more boundaries of the polygon associated with the restricted geographic area.

2. The UE of claim 1, wherein the one or more processors are individually or collectively further operable to execute the code to cause the UE to:
receive one or more messages indicating an area type indicator for the restricted geographic area, the area type indicator indicating that the restricted geographic area is a no fly zone, a no uplink transmission zone, or a no departure zone.

3. The UE of claim 1, wherein receiving the one or more messages indicating the geographic coordinates is based at least in part on a capability of the UE.

4. The UE of claim 1, wherein the one or more messages indicates:
the geographic coordinates of the restricted geographic area and at least one frequency band associated with the restricted geographic area; or
the geographic coordinates of the restricted geographic area, the at least one frequency band associated with the restricted geographic area and a time period during which the transmission restriction policy applies.

5. The UE of claim 1, wherein the one or more processors are individually or collectively further operable to execute the code to cause the UE to:
receive a control message that enables or disables the transmission restriction policy for the restricted geographic area.

6. The UE of claim 1, wherein the transmission restriction policy indicates a restriction prohibiting transmission using at least a first frequency band within the restricted geographic area, permits transmission using a second frequency band within the restricted geographic area, or both.

7. The UE of claim 1, wherein, to perform the procedure, the one or more processors are individually or collectively operable to execute the code to cause the UE to:
transmit a first message in accordance with a transmission power limit.

8. The UE of claim 1, wherein, to receive the one or more messages, the one or more processors are individually or collectively further operable to execute the code to cause the UE to:
receive a radio resource control message, a system information block, a downlink control information message, or a medium access control element message, based at least in part on the UE being disposed inside of a coverage area associated with a network entity.

9. The UE of claim 1, wherein, to receive the one or more messages, the one or more processors are individually or collectively further operable to execute the code to cause the UE to:
receive one or more application layer messages or one or more sidelink messages based at least in part on the UE being disposed outside of a coverage area associated with a network entity.

10. The UE of claim 1, wherein, to receive the one or more messages, the one or more processors are individually or collectively further operable to execute the code to cause the UE to:
receive a bit field comprising a barring bit indicating whether establishing connectivity with a cell within the restricted geographic area is barred.

11. The UE of claim 1, wherein, to receive the one or more messages, the one or more processors are individually or collectively further operable to execute the code to cause the UE to:
receive a network signaling field comprising a value indicating that establishing connectivity with a cell is permitted when the UE is located outside of the restricted geographic area and that establishing connectivity with the cell is not permitted when the UE is located within the restricted geographic area.

12. The UE of claim 11, wherein the network signaling field comprises a first network signaling value indicating an area type, a second network signaling value indicating the geographic coordinates, or both, or wherein the geographic coordinates are associated with an altitude for the restricted geographic area.

13. The UE of claim 1, wherein, to receive the one or more messages, the one or more processors are individually or collectively further operable to execute the code to cause the UE to:
receive signaling indicating that transmission is barred in the restricted geographic area or indicating permission to transmit in accordance with the transmission restriction policy in the restricted geographic area.

14. A method for wireless communications at a user equipment (UE), comprising:
receiving one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area; and
performing a procedure that complies with the transmission restriction policy based at least in part on a current geolocation of the UE relative to the geographic coordinates corresponding to the one or more boundaries of the polygon associated with the restricted geographic area.

15. The method of claim 14, further comprising:
receiving one or more messages indicating an area type indicator for the restricted geographic area, the area type indicator indicating that the restricted geographic area is a no fly zone, a no uplink transmission zone, or a no departure zone.

16. The method of claim 14, wherein receiving the one or more messages indicating the geographic coordinates is based at least in part on a capability of the UE.

17. The method of claim 14, wherein the one or more messages indicates:
the geographic coordinates of the restricted geographic area and at least one frequency band associated with the restricted geographic area; or
the geographic coordinates of the restricted geographic area, the at least one frequency band associated with the restricted geographic area and a time period during which the transmission restriction policy applies or at least one frequency band associated with the restricted geographic area.

18. The method of claim 14, further comprising:
receiving a control message that enables or disables the transmission restriction policy for the restricted geographic area.

19. The method of claim 14, wherein the transmission restriction policy indicates a restriction prohibiting transmission using at least a first frequency band within the restricted geographic area, permits transmission using a second frequency band within the restricted geographic area, or both.

20. A non-transitory computer-readable medium storing code for wireless communications, the code comprising instructions executable by one or more processors to:
receive one or more messages indicating geographic coordinates of a restricted geographic area, the geographic coordinates corresponding to one or more boundaries of a polygon that defines an area or a volume of the restricted geographic area, the one or more messages further indicating a transmission restriction policy associated with the restricted geographic area; and
perform a procedure that complies with the transmission restriction policy based at least in part on a current geolocation of the non-transitory computer-readable medium relative to the geographic coordinates corresponding to the one or more boundaries of the polygon associated with the restricted geographic area.
